(19) United States
(12) Patent Application Publication
(10) Pub. No.: US 2019/0072148 A1
(43) Pub. Date: Mar. 7, 2019

(54) DAMPING FORCE VARIABLE VALVE

(71) Applicant: AISIN SEIKI KABUSHIKI KAISHA, Kariya-shi (JP)

(72) Inventor: Kosuke Sakai, Obu-shi (JP)

(73) Assignee: AISIN SEIKI KABUSHIKI KAISHA, Kariya-shi (JP)

(21) Appl. No.: 16/109,374

(22) Filed: Aug. 22, 2018

(30) Foreign Application Priority Data
Sep. 4, 2017 (JP) 2017-169168

(51) Int. Cl. F16F 9/46; F16F 9/19; F16F 9/34; F16F 9/348; F16K 31/124

(52) U.S. Cl. CPC F16F 9/469; F16F 9/19; F16F 9/34; F16F 9/3415; F16F 2228/066; F16F 9/461; F16K 31/1245; F16F 2224/025; F16F 2224/0208; F16F 9/348

(57) ABSTRACT

A damping force variable valve includes a case accommodating working fluid, a housing, a first fluid chamber, a second fluid chamber, and a valve element provided at the housing. The valve element includes a first end portion configured to be in contact with a first contact portion formed at a part of the housing, the valve element configured to perform reciprocating motion within an inner space portion of the housing. The damping force variable valve includes an actuator provided at the housing and including a second contact portion configured to be in contact with a second end portion of the valve element. One of the first end portion, the first contact portion, the second end portion and the second contact portion is provided with a communication portion including an opening. An opening area of the opening changes in accordance with a pressing force from the actuator.

### CROSS REFERENCE TO RELATED APPLICATIONS

This application is based on and claims priority under 35 U.S.C. § 119 to Japanese Patent Application 2017-169168, filed on Sep. 4, 2017, the entire content of which is incorporated herein by reference.

### TECHNICAL FIELD

This disclosure generally relates to a damping force variable valve.

### BACKGROUND DISCUSSION

A known damping force variable valve provided in a shock absorber for a vehicle adjusts a damping force at an initial stage at which a suspension starts operating, that is, a stage at which a speed of a housing relative to a case is still low, and thus a steering stability and/or a ride quality changes significantly.

For example, such a known damping force variable valve is described in JP2003-278819A which will be referred to also as Patent reference 1.

The technique described in Patent reference 1 includes a cylinder in which working fluid is encapsulated, a piston which is slidable inside the cylinder, a rod of which an end is connected to the piston and of which the other end is extended outside the cylinder, an oil passage provided at the inside of the cylinder and allowing the working fluid to flow as the piston moves, and a damping force adjustment valve of a pilot type which controls flows of the working fluid in the oil passage and generating a damping force.

The damping force adjustment valve is formed at a slider penetrating the inside of the cylinder and made to move in a reciprocating manner inside the cylinder by a solenoid and a plunger. The damping force adjustment valve includes a flow control valve controlling an amount of flow of the working fluid and a pressure control valve determining a pilot pressure of a back pressure chamber arranged to be adjacent to a space portion in which the slider moves.

The pressure control valve is provided at an end portion of the slider, the end portion which is positioned at a side opposite to a contact portion with the plunger, and adjusts an interval space between a valve seat provided at the cylinder. When the interval space decreases, the flow amount of the working fluid is limited, and thus a pressure difference between the working fluids existing across the pressure control valve increases. As a result, the pilot pressure increases, thereby making another valve to perform an opening operation to let the working fluid flow and generating a damping force, for example.

The flow control valve is arranged in a manner that a step portion is provided at an outer circumferential surface of the slider, at a position which is slightly away from the pressure control valve towards the plunger. When a position of the slider changes, area of a gap formed between an inner surface of the cylinder and the step portion is adjusted, and thus the flow control valve determines the flow amount of the working fluid.

The flow control valve and the pressure control valve are provided at the same slider to be away from each other with a predetermined interval provided therebetween in a manner that the flow control valve and the pressure control valve are positioned in series with each other on a flowing route of the working fluid. By forming both control valves integrally with each other, it is set such that an opening degree of the flow control valve decreases when an opening degree of the pressure control valve decrease as the slider moves, for example.

According to the above-described configuration, the respective opening degrees of the flow control valve and the pressure control valve are set to be small when the flow amount of the working fluid is still small in an initial state in which the shock absorber starts operating. As described above, the known damping force variable valve is configured such that a fine or minor adjustment of the damping force can be made from the beginning of operation of the shock absorber.

According to the damping force variable valve described in Patent reference 1, however, in a case where a dimensional accuracy of the slider and the cylinder is insufficient, imbalance of the flow amounts of working fluid occurs between the flow control valve and the pressure control valve. As a consequence, an intended damping function is not obtained.

In addition, in order to control the position of the slider, the slider and the plunger which are in contact with each other are sandwiched by two coil springs in such a manner that the position of the slider is set by a total biasing force of the coil springs, and a drive force of the solenoid. Accordingly, the components are arranged in an elongated manner in the moving direction of the piston and the number of components increases. Because a size of the apparatus increases, installation flexibility onto an apparatus, such as the shock absorber, which includes a limited mounting space, is deteriorated. In addition, even though the valve is mounted on the apparatus, an efficiency or performance of the suspension decreases as the stroke of the piston is limited, for example.

Further, as a result of the increased number of components, the flow paths of the working fluid are complicated and a stable damping force may not be obtained.

A need thus exists for a damping force variable valve which is not susceptible to the drawback mentioned above.

### SUMMARY

A damping force variable valve includes a case accommodating working fluid, and a housing dividing an inside of the case into a first fluid chamber and a second fluid chamber. The housing includes a first hole provided at an outer circumferential wall of the housing, the first hole allows an inner space portion of the housing and the first fluid chamber to be in fluid communication with each other. The housing includes a second hole provided at an end portion of the housing in a direction of an axis, the second hole allows the inner space portion and the second fluid chamber to be in fluid communication with each other. The damping force variable valve includes a valve element provided at the housing and including a cylindrical shape. The valve element includes a first end portion configured to be in contact with a first contact portion formed at a part of the housing. The valve element divides the inner space portion into a first hole pilot chamber being in fluid communication with the first hole and a second hole pilot chamber being in fluid communication with the second hole, and the valve element is configured to perform reciprocating motion within the inner space portion in the direction of the axis, a position of the valve element at which the valve element is in contact with the first contact portion corresponding to an end point of the reciprocating motion. The damping force variable valve includes an actuator provided at the housing and including a second contact portion configured to be in contact with a second end portion of the valve element, the second end portion is provided at a side which is opposite to the first end portion in the direction of the axis. The actuator is configured to move along the axis and set a position of the valve element. At least one of the first end portion, the first contact portion, the second end portion and the second contact portion is provided with a communication portion including an opening configured to allow the first hole pilot chamber and the second hole pilot chamber to be in fluid communication with each other, and an opening area of the opening changes in accordance with a pressing force from the actuator.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a diagram illustrating a configuration of a damping force variable valve according to a first embodiment disclosed here;

FIG. 2 is a diagram illustrating the configuration of the damping force variable valve according to the first embodiment;

FIG. 3 is a perspective view illustrating a configuration of a first valve element according to the first embodiment;

FIG. 4A is a diagram explaining the first valve element and a valve seat according to the first embodiment disclosed here;

FIG. 4B is a diagram explaining the first valve element and the valve seat according to a second embodiment disclosed here;

FIG. 4C is a diagram explaining the first valve element and the valve seat according to a third embodiment disclosed here;

FIG. 4D is a diagram explaining the first valve element and the valve seat according to the third embodiment;

FIG. 5 is a diagram explaining operation manners of the first valve element and a second valve element according to the first embodiment;

FIG. 6 is a perspective view illustrating the first valve element according to a fourth embodiment disclosed here;

FIG. 7 is a diagram explaining a first slit according to a fifth embodiment disclosed here; and

FIG. 8 is a diagram explaining a configuration of the damping force variable valve according to an eighth element disclosed here.

### DETAILED DESCRIPTION

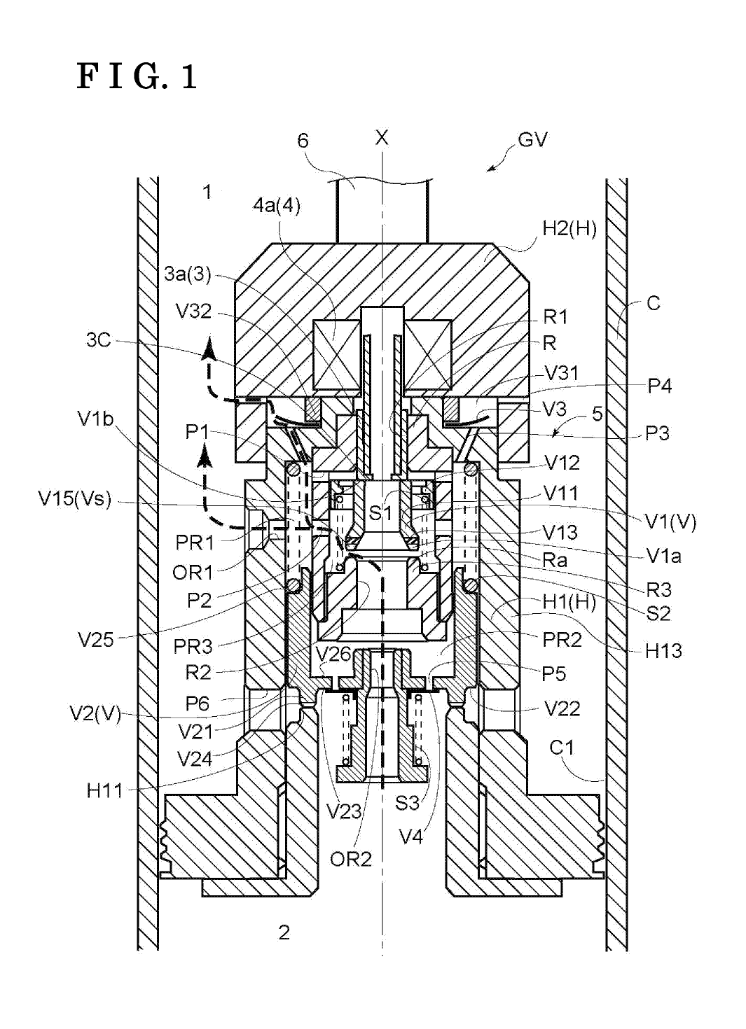

A damping force variable valve GV according to a first embodiment of the present disclosure will be described with reference to FIGS. 1 to 4. The damping force variable valve GV is applicable, for example, to a shock absorber of an automobile. In the damping force variable valve GV, a housing H slides relative to an inner surface C1 of a case C and changes an amount of flow of working fluid flowing inside the housing H, thereby to adjust a moving speed of the housing H.

The case C includes a cylindrical or tubular shape, for example. The housing H is provided at an inside the case C to be movable in a reciprocating manner in a direction of an axis X of the case C while the housing H is being in contact with the inner surface C1 of the case C. The housing H is mounted on a distal end of a rod 6. Another end portion of the rod 6 is connected to a frame of a vehicle and an end portion of the case C is connected to a suspension of a wheel, for example. An inner space portion of the case C is partitioned or divided by the housing H into a first fluid chamber 1 and a second fluid chamber 2. The housing H includes a first housing H1 and a second housing H2 which are arranged side by side with each other along the direction of the axis X of the case C. The first housing H1 and the second housing H2 are connected to each other by threadedly screwing and/or by fitting.

The first housing H1 includes a flow path allowing the first fluid chamber 1 and the second fluid chamber 2 to be in fluid communication with each other. The first housing H1 includes a control mechanism 5 provided at an inside the first housing H1. The control mechanism 5 adjusts the amount of flow of the working fluid flowing across the first fluid chamber 1 and the second fluid chamber 2, that is, from the first fluid chamber 1 to the second fluid chamber 2 and from the second fluid chamber 2 to the first fluid chamber 1, and thereby controlling an operation speed of the housing H.

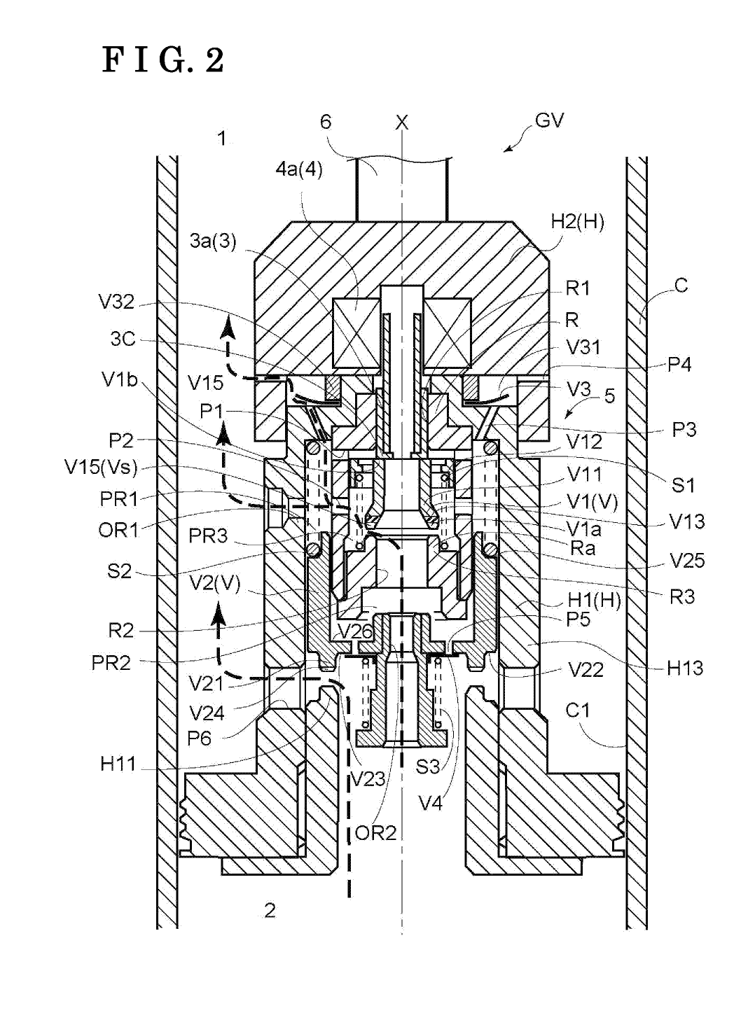

A retainer R including a substantially cylindrical or tubular shape is integrally provided at an inside of the first housing H1 in such a manner that the retainer R forms a double structure relative to the first housing H1. In the embodiment, the retainer R corresponds to a part of the first housing H1 and the retainer R accommodates a first valve element V1 serving as an example of a valve element V, which will be described below. A second valve element V2, which will be described below, is accommodated in a space portion formed between the first housing H1 and the retainer R. A first pilot chamber PR1 serving as a first hole pilot chamber is formed in the space portion between the first housing H1 and the retainer R. The first pilot chamber PR1 is in fluid communication with the first fluid chamber 1 via a first orifice OR1 serving as a first hole. The first orifice OR1 is set to include a predetermined opening area, and a flow amount of the working fluid passing through the first orifice OR1 is limited to a predetermined amount. For example, as illustrated in FIGS. 1 and 2, the first orifice OR1 includes the opening at a side wall of the cylindrical shape of the first housing H1 to open in a radial direction.

The first valve element V1 including a cylindrical shape is provided inside the retainer R and divides or partitions an inner space portion of the retainer R into two. The first valve element V1 includes a main body portion V11 including a substantially cylindrical shape and a flange portion V12 including an annular shape projecting from the main body portion V11 towards a radially outer side. The first valve element V1 is configured to move in a reciprocating manner by a predetermined distance along the direction of the axis X while the flange portion V12 slides on an inner surface of the retainer R.

A first port P1 and a second port P2 are provided at a side wall of the retainer R to be away from each other along the direction of the axis X in a manner that the first port P1 is arranged to be closer to the second housing H2 than the second P2. That is, the first port P1 and the second port P2 are arranged in the above-stated order from a side closer to the second housing H2. A guide hole R1 is provided at an end portion, in the direction of the axis X, of the retainer R, the end portion which is at a side where a solenoid 4a (i.e., an actuator 4) is provided. The solenoid 4a will be described later. A plunger 3a is inserted through the guide hole R1 and the guide hole R1 serves as a guide for the plunger 3a. On the other hand, at the other end portion of the retainer R, the end portion which is opposite to the above-described end portion at which the guide hole R1 is provided, a bottom hole R2 is formed to penetrate the retainer R in the direction of the axis X. At the bottom hole R2, a first valve seat R3 including an annular shape is formed. The first valve seat R3 serves as a first contact portion Ra with which a first end portion V1a of the first valve element V1 is configured to be in contact.

The first pilot chamber PR1 is formed in the space portion between the retainer R and the first housing H1. The first pilot chamber PR1 is in fluid communication with the first fluid chamber 1 via the first orifice OR1. On the other hand, the first port P1 and the second port 2 which are provided at the circumferential wall of the retainer R allow a third pilot chamber PR3 inside the retainer R and the first pilot chamber PR1 to be in fluid communication with each other. Similarly to the first pilot chamber PR1, the third pilot chamber PR3 functions as the first hole pilot chamber. The bottom hole R2 provided at the bottom portion of the retainer R is in fluid communication with the second pilot chamber PR2 serving as a second hole pilot chamber provided outside the retainer R.

A first spring S1 including, for example, a coil configuration, is provided around the first valve seat R3 of the retainer R and always biases or pushes the flange portion V12 of the first valve element V1 towards the plunger 3a. The first spring S1 serves as an example of a biasing member. The plunger 3a is driven by, for example, the solenoid 4a provided at the second housing H2 and serving as the actuator 4. A second contact portion 3c provided at an end portion of the solenoid 4a is in contact with a second end portion V1b provided at the first valve element V1 at a side opposite to the first end portion V1a, and thus a position of the first valve element V1 in the direction of the axis X is changed thereby to adjust the flow amount of the working fluid, accordingly, an adjustment mechanism 3 including, for example, the plunger 3a, is configured.

The actuator 4 is configured by the solenoid 4a as described above, and thus, for example, the plunger 3a arranged inside is caused to perform a parallel displacement due to a magnetic force. Accordingly, the structure for pressing or pushing the first valve element V1 can be arranged in a space-saving manner. In addition, a predetermined pressing force or pushing force is obtained easily relative to a power supply amount. By combining with deformation characteristics of a communication portion Vs, which will be described below, the damping force variable valve GV that is inexpensive and includes the compact structure is obtained.

As the plunger 3a moves back towards the solenoid 4a, an interval space or a distance from the first end portion V1a of the first valve element V1 to the first valve seat R3 increases, thereby increasing an amount of the working fluid flowing across the first pilot chamber PR1 and the second pilot chamber PR2 that is in fluid communication via the bottom hole R2 of the retainer R. Contrary to this, when the plunger 3a is pushed out to the third pilot chamber PR3, the first end portion V1a of the first valve element V1 is in contact with the first valve seat R3. In the embodiment, however, a first slit V15 serving as an example of the communication portion Vs is provided at the first end portion V1a to extend in the radial direction, and thus a certain amount of the working fluid is allowed to flow. The first slit V15 is configured such that an opening area of the first slit V15 changes in accordance with a pressing force or pushing force of the plunger 3a, which will be described below. When the first valve element V1 is in contact with the first valve seat R3, the flow amount of the working fluid decreases, and an effect to damp or attenuate the sliding movement of the housing H is maximized.

As illustrated in FIG. 1, a conic portion V13 is provided at an end portion of the main body portion V11 of the first valve element V1. In a state where the plunger 3a is protruding by a predetermined length towards the third pilot chamber PR3, the second end portion V1b of the first valve element V1 is pushed against the plunger 3a by the first spring S1 and a gap including a certain distance is formed between the first valve element V1 and the first valve seat R3.

Due to the conic portion V13 formed as described above, when the housing H is pushed towards the second fluid chamber 2 and an internal pressure of the second pilot chamber PR2 is higher than an internal pressure of the third pilot chamber PR3, the pressure of the working fluid acts on an inner surface of the conic portion V13 and the second end portion V1b of the first valve element V1 is pushed against the plunger 3a.

Contrary to this, when the housing H is drawn towards the first fluid chamber 1 and the internal pressure of the third pilot chamber PR3 is higher than the internal pressure of the second pilot chamber PR2, the pressure of the working fluid acts on an outer surface of the conic portion V13 and the first end portion V1a of the first valve element V1 is pushed against the first valve seat R3.

As described above, because the first valve element V1 is configured to be pushed against either side, it is restricted that pulsation occurs and the first valve element V1 vibrates in an reciprocating manner inside the retainer R, when the working fluid flows beyond the end portion of the first valve element V1. Consequently, the damping force variable valve GV, in which a flowing state of the working fluid is stabilized and, for example, the vibrations are restricted from occurring, is achieved.

In the embodiment, the first slit V15 (i.e., the communication portion) that allows the first pilot chamber PR1 and the second pilot chamber PR2 to be in fluid communication with each other is provided at the first end portion V1a of the first valve element V1. The first slit V15 (i.e., the communication portion) is an opening through which the working fluid can flow between the first pilot chamber PR1 and the second pilot chamber PR2. In the embodiment, the first slit V15 is provided as the opening.

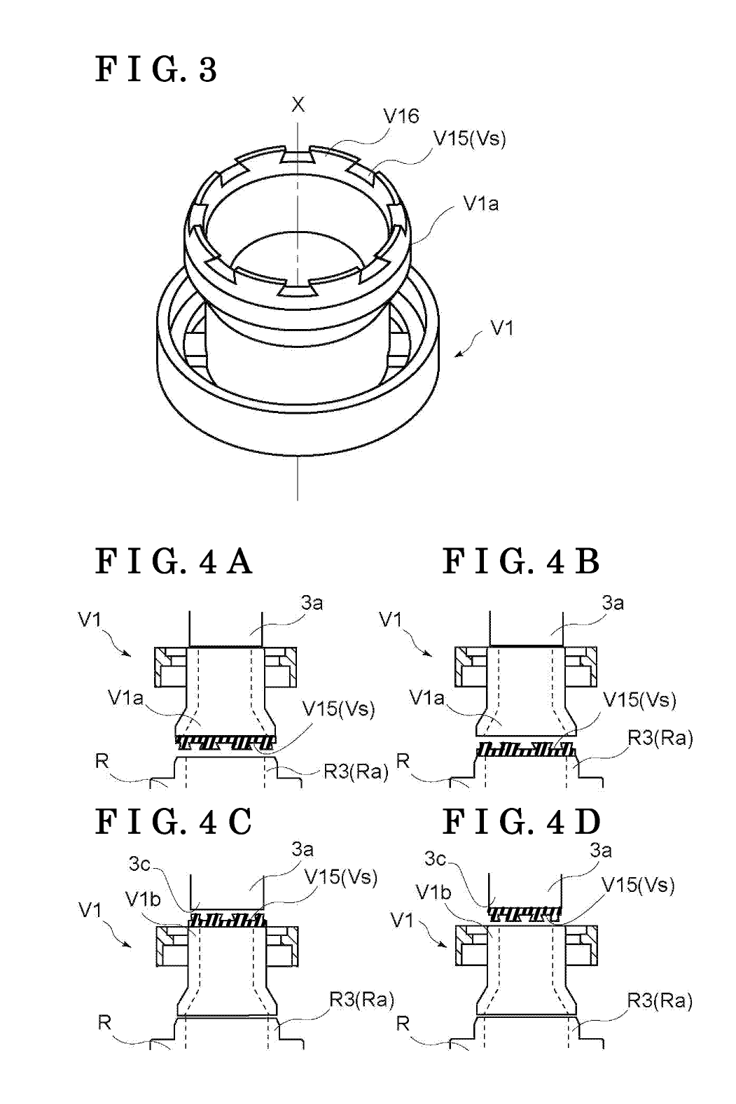

As illustrated in FIG. 3, the first slit V15 of the first end portion V1a may be formed of an elastic material including an annular shape, for example. The first slit V15 of the first end portion V1a may be formed of a rubber member or a rubber material including an annular shape, for example. A cross-sectional shape of the rubber member cut along a plane including the axis X of the first valve element V1 is a trapezoid shape in which a thickness becomes thinner towards a distal end of the first end portion V1a. Cut-out portions are provided repetitively at the rubber member along a circumferential direction to form the first slits V15. A protrusion 16 protruding towards the first valve seat R3 is formed between the adjacent first slits V15.

When one of the first slits V15 is seen along the radial direction, a width of the cut-put portion in the circumferential direction at an opening side is smaller, and a width of the cut-put portion in the circumferential direction at a bottom portion is larger. Accordingly, when the plunger 3a pushes the first valve element V1 against the first valve seat R3, a distal end portion of each of the protrusions 16 is compressed and deformed in the direction of the axis X, which allows the first slits V15 to be closed easily.

Contrary to this, the width of the one of the first slits V15 may be larger in the circumferential direction at the opening side and the width of the one of the first slits V15 may be smaller in the circumferential direction at the bottom portion. In this case, volume of the rubber material which should be deformed when being pushed by the plunger 3a is small, and thus the first slits V15 may be easily closed.

When forming the first slits V15 described above, an end portion of the rubber member may be simply cut off, for example. By deciding the dimensions of each cut-out portion, which includes a width in a circumferential direction of the rubber member, a height in the direction of the axis X and/or a depth in a radial direction of the rubber member, an amount of flow of the working fluid is set freely. In a case where the plural first slits V15 are provided at the elastic material along the circumferential direction, a cross-sectional shape of the elastic material between the adjacent first slits V15 may be set appropriately, and thus an amount of deformation due to the solenoid 4a (i.e., the actuator 4) is set easily.

In regard to the dimensions of the first slit V15, an influence of a height, in the direction of the axis X, of the slit on the flow amount of the working fluid is the cube of an influence of a width and/or a depth of the slit on the basis of, for example, an expression for pressure-loss between parallel plates (a deformation or transformation of the formula for the Hagen-Poiseuille flow). Thus, even a fine deformation in a height direction can influence and change a pressure loss significantly, and the flow amount of the working fluid can be adjusted sufficiently.

In addition, since the rubber material is used, a noise is restricted from occurring when the first valve element V1 comes in contact with the first valve seat R3 serving as the first contact portion Ra, and accordingly the damping force variable valve GV including a high quality is obtained.

As the rubber member, a member configured separately from the first valve element V1 may be attached to the first valve element V1. A member may be formed integrally with the first valve element V1.

Since the first slit V15 (i.e., the communication portion Vs) is formed of the rubber member that is deformable, various types of solenoid 4a and/or motor can be used as the actuator 4, for example. Control which is generally used in this case is the control changing torque to be generated according to the power supply amount, for example. If, for example, an amount of displacement is to be controlled, a measuring apparatus including an encoder and/or a linear sensor is additionally needed.

However, in the present embodiment in which the control can be performed mainly on the basis of the amount of power supply, which is a relatively rough control, the opening area of the first slit V15 is changed accurately while errors generated in the control of the amount of power supply is reduced, due to the combination with the first slit V15 of which the opening area is changed by the pressing force. Thus, the flow amount of the working fluid is controlled accurately with a simple configuration even at an initial stage of an opening operation of the first valve element V1 (i.e., the valve element) regardless of a flow direction of the working fluid.

In a case where the solenoid 4a (i.e. the actuator) fails to operate, the plunger 3a is pushed into the inside of the first housing H1 by the first spring S1, and the first valve element V1 is in a fully-open state relative to the first valve seat R3. In this case, the first slit V15 does not influence flow characteristics of the working fluid, and accordingly a damping function expected at failure is reliably performed.

Since the first slit V15 serving as the communication portion Vs is provided at the first end portion V1a as described above, weight of the first valve element V1 is reduced and a damping response during a normal operation is enhanced. Further, the pre-set damping function is performed when the solenoid 4a fails.

As illustrated in FIGS. 1 and 2, the damping force variable valve GV of the embodiment includes the second valve element V2 provided between a wall portion H13 of the first housing H1 and the retainer R. The second valve element V2 includes a substantially cup-shape and moves within the first housing H1 in a reciprocating manner along the axis X in a predetermined range, inside the first housing H1. Thus, a gap between the first housing H1 is increased and decreased, and an amount of the working fluid flowing across or between the first fluid chamber 1 and the second fluid chamber 2 is changed, thereby adjusting a damping effect. As will be described blow, the second valve element V2 moves when the moving speed of the housing H relative to the case C is fast and a difference between the internal pressure of the first pilot chamber PR1 and the internal pressure of the second pilot chamber PR2 is larger than a predetermined value. Thus, the flow amount of the working fluid flowing across or between the first fluid chamber 1 and the second fluid chamber 2 is increased.

A second spring S2 including a coil shape is provided between a bottom surface (at the upper side in FIG. 1) of the first housing H1 and an end surface V25 of the second valve element V2, and the second valve element V2 is always biased by the second spring S2 towards a side opposite to the solenoid 4a. A standing wall portion V21 including an annular shape is provided at a bottom portion of the second valve element V2. The standing wall portion V21 is provided at an outer peripheral portion of a surface of the bottom portion, the surface which faces towards the second fluid chamber 2. The standing wall portion V21 is configured to be in contact with a second valve seat H11 provided at the first housing H1 and includes an annular shape.

The standing wall portion V21 includes second slits V24 each formed along the radial direction in a manner that the second slits V24 are arranged dispersedly in a circumferential direction of the standing wall portion V21. Thus, as illustrated in FIG. 1, it is configured that a small amount of working fluid flows across or between the first fluid chamber 1 and the second fluid chamber 2 even in a state where the standing wall portion V21 is in contact with the second valve seat H11. As will be described below, an amount of flow of working fluid flowing across the first fluid chamber 1 and the second fluid chamber 2 is changed in accordance with a distance between the second valve seat H11 and the standing wall portion V21, thereby to adjust the damping effect.

A second orifice OR2 serving as a second hole is provided at the bottom portion of the second valve element V2 to penetrate the bottom portion in the direction of the axis X. The second orifice OR2 allows the second pilot chamber PR2 and the second fluid chamber 2 to be in fluid communication with each other. Each of the second orifice OR2 and the first orifice OR1 is set to include an opening area which is set in advance such that a predetermined amount of working fluid flows through.

A first check valve V3 is provided at a position between the first housing H1 and the second housing H2. A second check valve V4 is provided at the bottom portion of the second valve element V2. The first check valve V3 and the second check valve V4 are provided to be separate from each other. When the working fluid flows from the first fluid chamber 1 to the second fluid chamber 2, the first check valve V3 and the second check valve V4 ensure a discharge amount of the working fluid that is discharged to the second fluid chamber 2. When the working fluid flows from the second fluid chamber 2 to the first fluid chamber 1, the first check valve V3 and the second check valve V4 ensure a discharge amount of the working fluid that is discharged to the first fluid chamber 1.

The first check valve V3 is provided at the bottom portion of the first housing H1. Third ports P3 are provided at the bottom portion of the first housing H1 to be located at positions facing the first pilot chamber PR1 and to penetrate the bottom portion in the direction of the axis X. The third ports P3 are arranged dispersedly in the circumferential direction around the axis X and are in fluid communication with an annular space portion V31 provided between the first housing H1 and the second housing H2 that face each other in the direction of the axis X. From here, the annular space portion V31 is further in fluid communication with the first fluid chamber 1 via fourth ports P4 penetrating the wall portion H13 of the second housing H2 in the radial direction. Also the fourth ports P4 are arranged dispersedly in the circumferential direction relative to the wall portion H13 of the second housing H2.

The first check valve V3 includes a shape of a thin sheet or plate and is formed of, for example, an elastic or resilient member. The first check valve V3 is provided inside the annular space portion V31, at positions where the third ports P3 open, such that the first check valve V3 is configured to close the third ports P3. As a material forming the first check valve V3, a resin material, a metal sheet including resiliency or elasticity, and/or a rubber material can be used, for example. The first check valve V3 is fixed between the first housing H1 and the second housing H2 via a fixing member V32.

Plural fifth ports P5 are provided at the bottom portion of the second valve element V2 to be positioned in a region at an outer circumferential side relative to the second orifice OR2 and at an inner circumferential side relative to the standing wall portion V21. The fifth ports P5 are formed to penetrate the bottom portion and are arranged dispersedly in the circumferential direction. The second check valve V4 is provided at an outer surface of the bottom portion of the second valve element V2 to be located at a position where the second check valve V4 are configured to close the fifth ports P5. The second check valve V4 includes a shape of a thin annular sheet or plate. The second check valve V4 is always biased by, for example, a third spring S3 including a coil shape so that the second check valve V4 closes the fifth ports P5. When the working fluid is discharged from the second pilot chamber PR2 to the second fluid chamber 2 via the second orifice OR2, the second check valve V4 opens in a state where an internal pressure of the second pilot chamber PR2 increases to overcome or exceed the biasing force of the third spring S3. Thus, the discharge of the working fluid from the second pilot chamber PR2 is facilitated.

A basic operation manner of the control mechanism will be described hereunder. According to the damping force variable valve GV of the embodiment, the opening area of the first slits V15 provided at the first valve element V1 changes depending on a difference in an extent of the pushing or pressing performed by the plunger 3a. However, first, an operation manner of the first valve element V1 and the second valve element V2 will be described assuming that the opening area of the first slits V15 is constant.

For example, when the rod 6 is pushed downward in FIG. 1 and the housing H starts compressing the second fluid chamber 2, as illustrated with the arrows with dotted lines in FIG. 1, the working fluid in the second fluid chamber 2 flows into the second pilot chamber PR2 from the second orifice OR2, and then reaches the third pilot chamber PR3 via the first slits V15 of the first valve element V1. Further, via the first port P1 and the second port P2, the working fluid passes through the first pilot chamber PR1 and the first orifice OR1, and then is discharged to the first fluid chamber 1. At this time, the first check valve V3 opens.

Contrary to this, when the rod 6 is drawn and moves upward in FIG. 1, and the housing H starts compressing the first fluid chamber 1, the working fluid in the first fluid chamber 1 flows in a direction opposite to the direction of the arrows with the dotted lines in FIG. 1. The working fluid in the first fluid chamber 1 flows into the first pilot chamber PR1 from the first orifice OR1, and reaches the third pilot chamber PR3 via the first port P1 and the second port P2. Further, the working fluid passes through the second pilot chamber PR2 and the second orifice OR2 via the first slits V15 of the first valve element V1, and then is discharged to the second fluid chamber 2. At this time, the second check valve V4 opens against the biasing force of the third spring S3.

When the housing H rises or moves upward in FIG. 1, the internal pressure of the first pilot chamber PR1 increases due to the working fluid flowing therein via the first orifice OR1. However, a flow amount of the working fluid passing though the first orifice OR1 is limited to a constant amount, and accordingly an increase speed of the internal pressure of the first pilot chamber PR1 is limited to or held at a predetermined speed. However, when a speed at which the housing H moves upward is fast, pressure of the working fluid acting on a sixth port P6 increases rapidly, and accordingly pressure acting on an outer edge surface V22 of the bottom surface of the second valve element V2 becomes larger than pressure acting on the end surface V25 of the second valve element V2 inside the first pilot chamber PR1. Consequently, the second valve element V2 moves away from the second valve seat H11 against the biasing force of the second spring S2, and a space portion is generated between the second valve element V2 and the second valve seat H11. Via the generated space portion, the working fluid flows into the second fluid chamber 2 in a direction opposite to the direction indicated by the arrow with the dotted line in FIG. 2.

The pressure of the working fluid acting on the sixth port P6, that is, the pressure which is needed to move the second valve element V2, is determined by a position of the plunger 3a. That is, the more the plunger 3a protrudes towards the third pilot chamber PR3, the smaller the gap becomes between the first valve element V1 and the first valve seat R3. Accordingly, the working fluid flowing from the third pilot chamber PR3 out to the second pilot chamber PR2 is reduced. Thus, the increase of the internal pressure of the first pilot chamber PR1 when the working fluid flows into the first pilot chamber PR1 via the first orifice OR1 becomes fast. In this case, a difference between pressure acting on an outer surface V23 of the bottom portion of the second valve element V2 and pressure acting on the end surface V25 of the second valve element V2 is small, and thus the second valve element V2 does not perform an opening operation easily. As a result, an amount of flow of the working fluid discharged from the first fluid chamber 1 to the second fluid chamber 2 is limited, and the damping effect associated with the movement of the housing H increases.

When the housing H descends or moves downward in FIG. 1, the internal pressure of the second pilot chamber PR2 increases due to the working fluid flowing into the second pilot chamber PR2 via the second orifice OR2. However, an amount of flow of the working fluid passing through the second orifice OR2 is limited to a constant amount, and accordingly an increase speed of the internal pressure of the second pilot chamber PR2 is limited to or held at a predetermined speed. However, when a speed at which the housing H moves downward is fast, the pressure of the working fluid acting on the outer surface V23 of the bottom portion of the second valve element V2 increases rapidly, and accordingly the pressure acting on the outer surface V23 becomes larger than pressure acting on an inner surface V26 of the bottom portion of the second valve element V2 inside the second pilot chamber PR2. Thus, the second valve element V2 moves away from the second valve seat H11 against the biasing force of the second spring S2 and the working fluid flows towards the first fluid chamber 1 via a gap formed between the second valve element V2 and the second valve seat H11. Consequently, in a case where a large downward force acts on the housing H, the housing H can be moved downward relatively fast.

Also in a case where the housing H moves downward, the pressure required to separate or move the second valve element V2 from the second valve seat H11 is determined by the position of the plunger 3a. The more the plunger 3a protrudes towards the third pilot chamber PR3, the smaller the gap becomes between the first valve element V1 and the first valve seat R3. Accordingly, the working fluid flowing from the second pilot chamber PR2 out to the third pilot chamber PR3 is reduced. Thus, the increase of the internal pressure of the second pilot chamber PR2 when the working fluid flows into the second pilot chamber PR2 via the second orifice OR2 becomes fast. In this case, a difference between the pressure acting on the outer surface V23 of the bottom portion of the second valve element V2 is small, and thus the second valve element V2 does not perform the opening operation easily. As a result, an amount of flow of the working fluid discharged from the second fluid chamber 2 to the first fluid chamber 1 is limited, and the damping effect associated with the movement of the housing H increases.

By providing a difference between an inner diameter of the first orifice OR1 and an inner diameter of the second orifice OR2, the damping effect can be made different in accordance with a moving direction of the housing H. For example, in a case where the inner diameter of the first orifice OR1 is set to be larger than the inner diameter of the second orifice OR2, an extent of increment of the internal pressure of the first pilot chamber PR1 is larger than an extent of increment of the internal pressure of the second pilot chamber PR2. That is, in a case where the internal pressure of the first pilot chamber PR1 is increased due to the rising of the housing H, the difference from the pressure acting on the outer surface V23 of the bottom portion of the second valve element V2 via the sixth port P6 is small, and thus a moving amount of the second valve element V2 is small. In this case, consequently, the damping effect of the housing H may increase.

In a case where the solenoid 4a fails to operate, the control mechanism 5 operates as follows. Due to the biasing force of the first spring S1, the plunger 3a is pushed by the first valve element V1 and withdraws towards the second housing H2. As a result, the first valve V1 moves to a position at which the first valve element V1 is in contact with the bottom portion of the first housing H1, and the first port P1 is closed or blocked with the flange portion V12 of the first valve element V1. Thus, the first pilot chamber PR1 and the third pilot chamber PR3 are in fluid communication with each other only via the second port P2. The opening area of the second port P2 is formed to include a predetermined size and is set to be smaller than the opening area of the first orifice OR1 or than an area of the gap formed between the first valve element V1 and the first valve seat R3. Consequently, in a case where the solenoid 4a fails to operate, the flow of the working fluid is controlled by the second port P2.

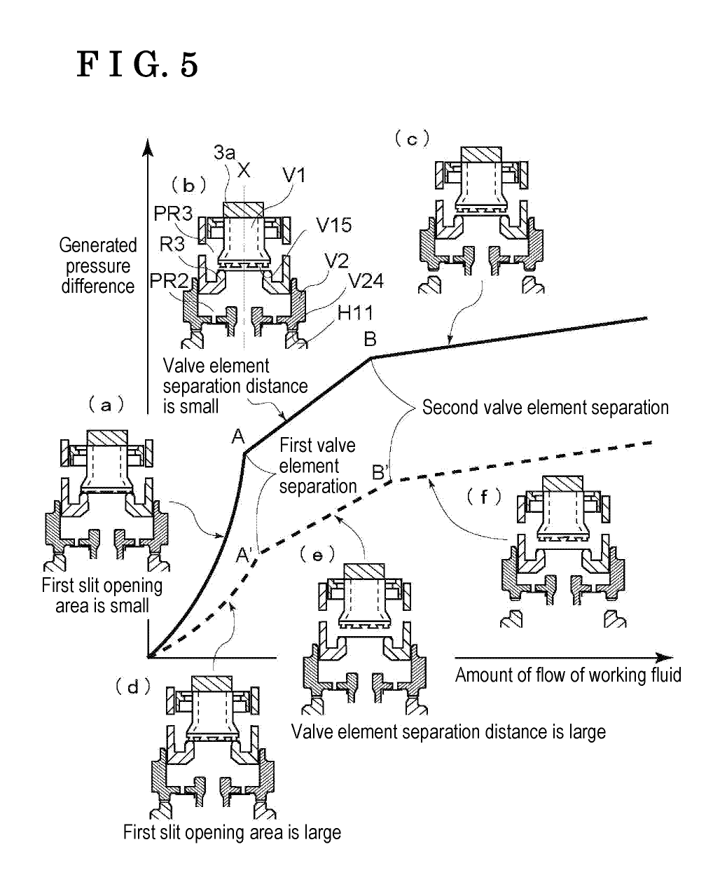

An operation manner by adjusting the opening area of the first slit V15 serving as the communication portion Vs will be described hereunder. FIG. 5 illustrates the operation manner of the damping force variable valve GV in a case where the opening area of the first slits V15 of the first valve element V1 is changed. In FIG. 5, the horizontal axis corresponds to an amount of flow of the working fluid flowing between the first fluid chamber 1 and the second fluid chamber 2, and the vertical axis indicates a pressure difference generated between the first fluid chamber 1 and the second fluid chamber 2. At this time, the working fluid flows also via the second slits V24 provided between the second valve element V2 and the second valve seat H11.

In FIG. 5, the solid line indicates an example in which the first valve element V1 is pushed strongly by the plunger 3a, thereby reducing the opening area of the first slits V15. From the origin to a point A, a state is indicated in which the moving speed of the housing H is slow and the flow amount of the working fluid is small. In this state, the working fluid does not easily flow via the first slits V15 as illustrated in (a) of FIG. 5, and thus a pressure difference between the second pilot chamber PR2 and the third pilot chamber PR3 becomes large easily. Consequently, the pressure difference generated in association with the increment of the flow amount of the working fluid increases rapidly.

On the other hand, the dotted line in FIG. 5 indicates an example in which the pressing force of the plunger 3a relative to the first valve element V1 is reduced. In this case, as illustrated in (d) of FIG. 5, it is easy for the working fluid to pass through the first slits V15, and accordingly the increment of the generated pressure difference relative to the increment of the flow amount is gradual or gentle.

For example, at a time when the flow amount reaches the point A in the example indicated with the solid line, the solenoid 4a is operated to allow the plunger 3a to withdraw or move towards the second housing H2 by a small amount as illustrated in (b) of FIG. 5. Thus, the first valve element V1 becomes movable along the direction of the axis X by a predetermined distance, and the flow amount of the working fluid flowing between second pilot chamber PR2 and the third pilot chamber PR3 increases. As a result, the increment of the generated pressure difference relative to the flow amount of the working fluid is alleviated or lessened, and accordingly an inclination or tilt from the point A to a point B on the solid line becomes gentle.

Thereafter, when the moving speed of the housing H increases further and, for example, the flow amount between the first valve element V1 and the first valve seat R3 increases to reach the point B, the second valve element V2 performs the opening operation as illustrated in (c) of FIG. 5. Thus, the working fluid flows also between the second valve element V2 and the second valve seat H11, and accordingly the tilt of the increment of the generated pressure difference relative to the flow amount at and beyond the pint B becomes even more gradual or gentle.

Contrary to this, in the example indicated by the dotted line, an amount of the working fluid flowing via the first slits V15 is set to be large from the beginning. Therefore in a region from a point A′ to a point B′, the gap between the first valve element V1 and the first valve seat R3 is large as illustrated in (e) of FIG. 5. In a region beyond the point B′, the gap between the second valve element V2 and the second valve seat H11 becomes larger as illustrated in (f) of FIG. 5. Consequently, the extent of the increment of the generated pressure is more gentle or gradient than the examples indicated with the solid line.

In regard to the correlation between the flow amount of the working fluid and the generated pressure difference, the difference from the origin to the point A and the difference from the origin to the point A′ are determined on the basis of the difference of the opening area of the first slits V15. A region from the point A to the pint B, and a region from the point A′ to the point B′ are determined on the basis a set position of the first valve element V1 set by the solenoid 4a or on the basis of an extent of increment of a movable distance of the first valve element V1 due to the displacement of the solenoid 4a. For example, the interval space between the first valve element V1 and the first valve seat R3 in the region from the point A to the point B is set to be smaller or narrower than the interval space between the first valve element V1 and the first valve seat R3 in the region from the point A′ to the point B′. Further, a region beyond the point B and a region beyond the point B′ are determined on the basis of a spring constant of the second spring S2 pushing the second valve element V2 towards the second valve seat H11. The spring constant in the region beyond the point B indicated with the solid line is set to be more stiff, that is, larger, than the spring constant in the region beyond the point B′ indicated with the dotted line.

As described above, as a technique to adjust the opening area of the first slits V15, the rubber member is arranged at the first end portion V1a and the first valve element V1 is pushed or pressed with the use of the solenoid 4a. Accordingly, a fine adjustment of the opening areas can be made, while the structure of the control mechanism 5 being simple. That is, it is easier for the solenoid 4a to control the pressing force than to control a moving amount by increasing and reducing an amount of electrification. In addition, for example, a volume mechanism increasing and reducing the amount of electrification can be configured relatively easily, however, various position sensors are additionally needed when the moving distance of the solenoid 4a is to be measured accurately.

In order to solve the above-described inconvenience, in the embodiment, the rubber member including a predetermined shape is provided at the first end portion V1a of the first valve element V1 and the deformation amount of the rubber member is adjusted by changing the pressing force. Thus, in the embodiment, the effects equivalent to effects which will be obtained by performing a position control on the solenoid 4a are obtained.

A second embodiment disclosed here will be described hereunder. In the first embodiment, the first slit V15 (i.e., the communication portion Vs) is provided at the first end portion V1a of the first valve element V1 as illustrated in FIG. 4A, however, the position of the first slit V15 can be changed appropriately. For example, the first slit V15 may be provided at the first valve seat R3 (i.e., the first contact portion) of the retainer R as illustrated in FIG. 4B.

The opening state of the first valve element V1 is controlled by the solenoid 4a (i.e., the actuator 4) and the plunger 3a. Even in a case where the solenoid 4a fails to operate, the damping force variable valve GV is required to perform a predetermined damping function. In a case where the solenoid 4a fails to operate, the pressing force relative to the first valve element V1 is not performed and the first valve element V1 is displaced towards the solenoid 4a by the first spring S1. At this time, the first pilot chamber PR1 and the second pilot chamber PR2 are in fluid communication with each other in a state where the interval space between the first end portion V1a of the first valve element V1 and the first valve seat R3 is fully increased, that is, the first end portion V1a of the first valve element V1 and the first valve seat R3 are sufficiently away from each other.

In the above-described state, the first port P1 or the second port P2, which are provided at the housing H, limits the flow amount of the working fluid, and a predetermined damping effect is performed. In a state where the plunger 3a withdraws, the distance from the first end portion V1a and the first valve seat R3 is large enough, and thus the shape of the first slits V15 do not influence the flow amount of the working fluid. As described above, with the configuration illustrated in FIG. 4B and the configuration illustrated in FIG. 4A, the predetermined damping function is reliably performed when the solenoid 4a fails to perform.

A third embodiment disclosed here will be described hereunder. The first slit V15 can be provided at the second end portion V1b of the first valve element V1 as illustrated in FIG. 4C. The first valve element V1 constantly slides relative to the housing H, and repeatedly collides with the first valve seat R3 serving as the first contact portion Ra of the housing H and/or a distal end of the plunger 3a which corresponds to the second contact portion 3c. Thus, it is desired that the first slit V15 includes an abrasion resistance and/or strength as well as a corrosion resistance against the working fluid, for example.

Therefore, the first valve element V1 is often made of metal material including steel and/or aluminum, for example. However, for enhancing responsiveness of the damping characteristics, it is desired that the first valve element V1 is light so that the first valve element V1 moves easily in response to the flow of the working fluid and/or fluctuations of the pressure. By providing the first slits V15, at which the opening is formed and lightening or thinning of the material is conducted, at the second end portion V1b, the weight of the first valve element V1 is reduced. Thus, the damping mechanism including, for example, the enhanced responsiveness relative to the fluctuations of the pressure of the working fluid can be obtained. In a case where the first slits V15 are formed of the rubber member, the weight of the first valve member V1 is even more reduced, thereby facilitating convenience. The effect obtained by making the first valve element V1 light can be achieved in the example illustrated in FIG. 4A.

The first slit V15 serving as the communication portion Vs may be provided at an end portion of the plunger 3a as illustrated in FIG. 4D.

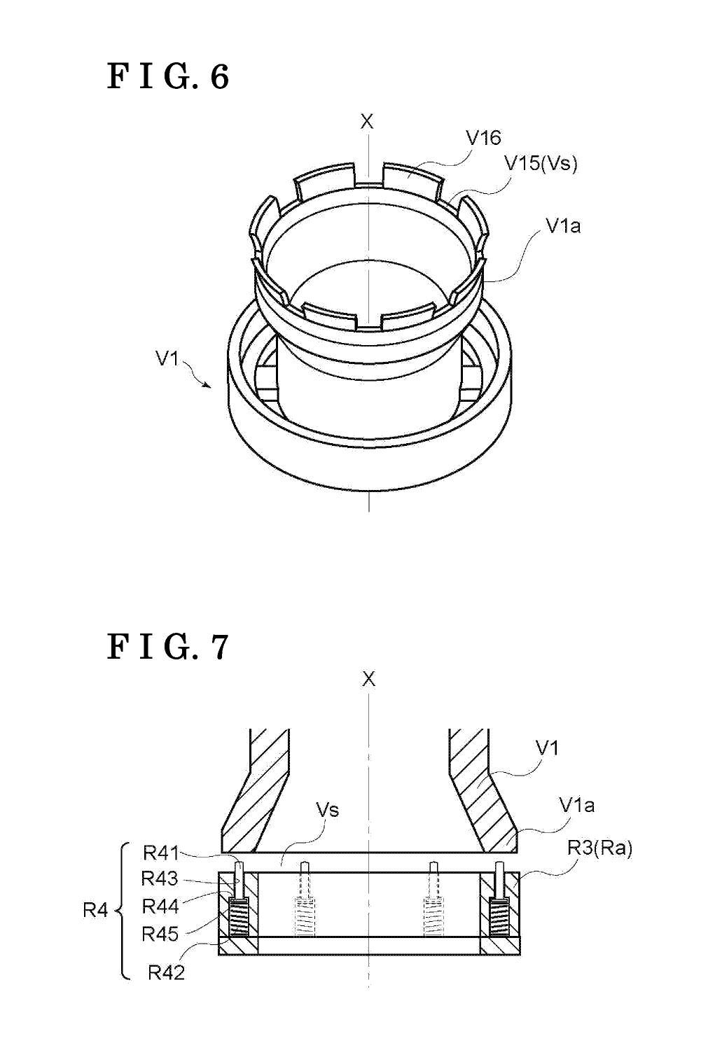

A fourth embodiment disclosed here will be described hereunder. The first valve element V1 can be embodied as illustrated in FIG. 6. That is, the communication portion Vs is formed of a rubber member and the plural first slits V15 are provided at a distal end portion of the rubber member. Protrusions V16 configuring the first slits V15 are formed to be slightly open or flared out in a radial direction relative to the axis X.

With the above-described configuration, when the protrusions V16 are pushed against the first valve seat R3, the protrusions V16 are bent radially outward and thus a diameter of the rubber member is increased. Accordingly, the opening area of the first slits V15 is reduced and the flow amount of the working fluid is limited. In a case where the bending of the rubber member as described above is utilized, it is possible that the pressing or pushing force of the plunger 3a is reduced compared to a case where the rubber member is compressively deformed. As a result, the solenoid 4a may be even more reduced in size, and thus a compact or space-saving damping force variable valve GV is obtained.

A fifth embodiment disclosed here will be described hereunder. The structure illustrated in FIG. 7 is also applicable to change the opening area of the first slits V15 by using the pressing force of the solenoid 4a. Here, a reaction force portion R4 receiving the pressing force of the plunger 3a is provided at the first valve seat R3 instead of allowing the first valve element V1 and/or the first valve seat R3 to be deformed.

For example, at the reaction force portion R4, a pin member R41 and a coil spring R42 are arranged by insertion in the first valve seat R3. The reaction force portion R4 is configured such that the pin member R41 is movable to protrude and retract along a guide portion R43 including a tubular shape. In the example illustrated in FIG. 7, the pin member R41 is provided at, for example, six positions along a circumferential direction of the first valve seat R3. A collar portion R45 is provided at a base end portion of the pin member R41. The collar portion R45 is in contact with a stepped portion R44 provided at the guide portion R43. Thus, the pin member R41 protrudes by a predetermined length relative to the first valve seat R3.

When the plunger 3a pushes the first valve body V1 against the first valve seat R3, the first end portion V1a comes in contact with a distal end of the pin member R41 and receives a reaction force from the pin member R41. Thus, the gap between the first valve element V1 and the first valve seat R3 is adjusted in accordance with the pressing force of the plunger 3a, and consequently the opening area of the communication portion V is adjusted.

According to the configuration of the embodiment, even when the first valve element V1 is positioned to be closest to the first valve seat R3, the first valve element V1 is pushed by the pin member R41 and thus the opening serving as the communication portion Vs is formed between the first valve element V1 and the first valve seat R3. Accordingly, the working fluid flows via the opening even when the pressure difference between the first fluid chamber 1 and the second fluid chamber 2 is small, thereby allowing the damping effect to perform.

However, in order to ensure that the opening is provided between the first valve body V1 and the first valve seat R3, at least one of the first end portion V1a and the first valve seat R3 may be provided with a slit such that the working fluid can flow even in a state where the first valve element V1 and the first valve seat R3 are in contact with each other.

Further, as the mechanism that biases the pin member R41, a disc spring including an annular shape, and/or a leaf spring or a plate spring including a quadrilateral shape may be used instead of the coil spring R42. When the leaf or plate spring is used, a space portion in the direction of the axis X is reduced, and accordingly the reaction force portion R4 can be configured in a more space-saving manner. As described above, with the use of the metal spring, the size of the spring member which can produce resiliency or elasticity equivalent to the rubber member can be reduced, and durability against the working fluid is ensured easily.

A sixth embodiment disclosed here will be described hereunder. The rubber member provided at, for example, the first end portion V1a to configure the communication portion Vs may include plural protrusions. For example, the protrusions are provided to include a shape of spikes at a portion that is configured to be in contact with the first valve seat R3. In this case, by appropriately setting a thickness and/or a height of the protrusion, a force required to make the first valve element V1 to come close to the first valve seat R3 by a predetermined distance can be set freely. Consequently, the optimum control mechanism 5 that is in accordance with a pushing or pressing capability of the solenoid 4a is configured.

A seventh embodiment disclosed here will be described hereunder. As another example of a configuration of the communication portion Vs, for example, a rubber member including an annular shape may be provided at either one of the first end portion V1a of the first valve element V1 and the first valve seat R3, and the other may be formed of a rigid or stiff member including, for example, a metal material which is provided with plural slits formed along the circumferential direction. In this case, the rubber member is deformed when being compressed by the plunger 3a, however, a part of the rubber member which corresponds to the slit projects or protrudes into an inner portion of the slit. Thus, the opening area of the slits is reduced, thereby to limit the flow amount of the working fluid. According to this configuration, the rubber member includes a simple shape, and accordingly it is prevented that a part of the rubber member is torn and come off during the operation.

Alternatively, a rubber member may be provided at both of the first end portion V1a of the first valve element V1 and the first valve seat R3 to configure the communication portion Vs, for example.

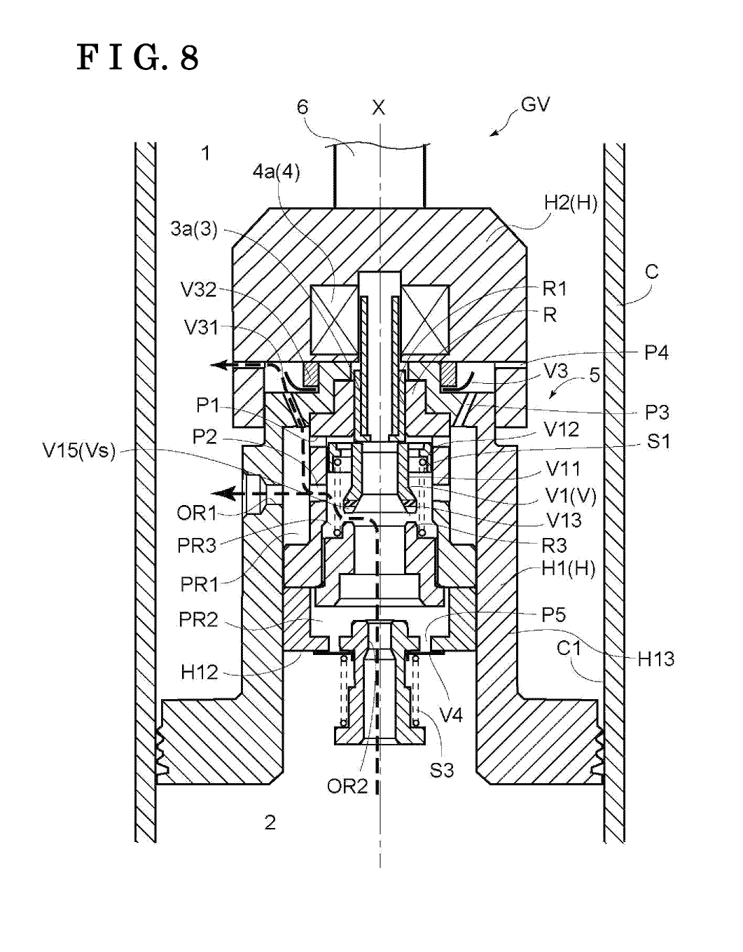

An eighth embodiment disclosed here will be described hereunder. The damping force variable valve GV disclosed here may be configured without including the second valve element V2 as illustrated in FIG. 8. In this case, the second orifice OR2 is provided at an end surface H12 of the first housing H1.

Also in this configuration, the first slit V15 (i.e., the communication portion Vs) where, for example, the rubber member is attached to the end portion of the first valve element V1 is provided. Thus, a fine adjustment of the shock absorbing effect can be made at a time when the moving speed of the housing H is slow and the flow amount of the working fluid is small.

In the embodiment, the shock absorbing function during the movement of the housing H is on the basis only of the adjustment of the position of the first valve element V1. Accordingly, a range of changes of the moving speed of the housing H is small compared to the first embodiment in which the second valve element V2 operates the opening and closing operation. In the present embodiment, for example, a stroke range of the first valve element V1 is set to be large, and an amount of changes of the interval space between the first valve element V1 and the plunger 3a or an amount of changes of the interval space between the first valve element V1 and the first valve seat R3 is made large. For this purpose, for example, the opening areas of the first orifice OR1, the second orifice OR2, the first port P1 and/or the second port P2, respectively, are appropriately set in accordance with the specifications of the first valve element V1. The dotted lines in FIG. 8 indicate the flow paths of the working fluid when the housing H moves downward.

In this case, the second valve element V2 is omitted and a length of the housing H is reduced accordingly. Thus, the compact or space-saving damping force variable valve GV is obtained.

The damping force variable valve GV according to the present disclosure is widely applicable as a valve at which the inside of the case is divided into the first fluid chamber and the second fluid chamber, and the amount of working fluid flowing between the first fluid chamber and the second fluid chamber is adjusted.

The present disclosure relates to the damping force variable valve including the case accommodating the working fluid, and the housing dividing the inside of the case into the first fluid chamber and the second fluid chamber. The damping force variable valve controls the movement of the valve element provided at the housing, thereby to adjust the moving characteristics of the housing. The damping force variable valve includes the simple configuration, and provides the efficient and stable damping characteristics even in a state where the flow speed of the working fluid is low and/or the flow amount of the working fluid is small.

According to the aforementioned embodiments, the damping force variable valve GV includes the case C accommodating the working fluid, the housing H dividing the inside of the case C into the first fluid chamber 1 and the second fluid chamber 2. The housing H includes the first hole OR1 provided at an outer circumferential wall of the housing, the first orifice OR1 (i.e., the first hole) allowing the inner space portion of the housing H and the first fluid chamber 1 to be in fluid communication with each other. The housing H includes the second orifice OR2 (i.e., the second hole) provided at the end portion of the housing H in the direction of the axis X. The second orifice allows the inner space portion and the second fluid chamber 2 to be in fluid communication with each other. The damping force variable valve GV includes the first valve element V1 (i.e., the valve element V) provided at the housing H and including the cylindrical shape. The first valve element V1 includes the first end portion V1a configured to be in contact with the first valve seat R3 (i.e., the first contact portion Ra) formed at a part of the housing H. The first valve element V1 divides the inner space portion into the first pilot chamber PR1 (i.e., the first hole pilot chamber) which is in fluid communication with the first orifice OR1 and the second pilot chamber PR2 (i.e., the second hole pilot chamber) which is in fluid communication with the second orifice OR2. The first valve element V1 is configured to perform the reciprocating motion within the inner space portion in the direction of the axis X. The position of the first valve element V1 at which the first valve element V1 is in contact with the first valve seat R3 corresponds to the end point of the reciprocating motion. The damping force variable valve GV includes the solenoid 4a (i.e., the actuator 4) provided at the housing H and including the second contact portion 3c configured to be in contact with the second end portion V1b of the first valve element V1. The second end portion V1b is provided at the side which is opposite to the first end portion V1a in the direction of the axis X. The solenoid 4a is configured to move along the axis X and set the position of the first valve element V1. At least one of the first end portion V1a, the first valve seat R3, the second end portion V1b and the second contact portion 3c is provided with the first slit V15 (i.e., the communication portion Vs) including the opening configured to allow the first pilot chamber PR1 and the second pilot chamber PR2 to be in fluid communication with each other. The opening area of the opening changes in accordance with the pressing force from the solenoid 4a.

According to the above-described configuration, in a state where the solenoid 4a presses or pushes the first valve element V1 and the pushed first valve element V1 is in contact with the first valve seat R3 (i.e., the first contact portion Ra of the housing H), the first valve element V1 divides or partitions the inside of the housing H into the first fluid chamber 1 and the second fluid chamber 2. The first slit V15 is provided at at least one of the first end portion V1a, the first valve seat R3, the second end portion V1b and the second contact portion 3c. The first slit V15 is configured such that the opening area of the opening changes or varies in response to strength or intensity of the pressing force from the solenoid 4a and that the flow amount of the working fluid flowing between the first or third pilot chamber PR1 or PR3 (i.e., the first hole pilot chamber) and the second pilot chamber PR2 (i.e., the second hole pilot chamber) changes.

According to the above-described configuration, in a state where the first end portion V1a of the first valve element V1 is in contact with the first valve seat R3, the opening of the first slit V15 is reduced in response to the pressing force of the solenoid 4a, and thus the amount of the working fluid flowing between the first fluid chamber 1 and the second fluid chamber 2 is limited. However, by reducing the pressing force of the solenoid 4a, the opening area of the opening increases. Thus, the flow amount of the working fluid increases.

For example, various types of motors and/or the solenoids may be used as the actuator 4. Generally, in this case, the control is performed which changes, on the basis of the power supply amount, the torque to be generated, for example. If, for example, an amount of displacement is to be controlled, measuring equipment including an encoder and/or a linear sensor is additionally needed. However, in the present disclosure where the control on the basis of mainly the amount of electrification can be applied, by combining the first slit V15 whose opening area is varied by the pressing force with the control on the basis mainly of the amount of electrification, the errors generated due to the control depending on the amount of electrification (which is relatively a rough control) is reduced, and the amount of electrification is converted into the amount of deformation of the first slit V15. Thus, the flow amount of the working fluid is controlled accurately with the simple configuration even at the initial stage of the opening operation of the first valve element V1, regardless of the flow direction of the working fluid.

According to the aforementioned embodiment, the first slit V15 is provided at at least one of the first end portion V1a and the second end portion V1b.

According to the above-described configuration, the first valve element V1 slides with respect to the housing H, and repeatedly collides with the first valve seat R3 and/or the second contact portion 3c of the solenoid 4a. Thus it is desired that, the first valve element V1 has the abrasion resistance and/or the strength as well as the corrosion resistance against the working fluid, for example. Therefore, the first valve element V1 is often made of metal material such as steel and/or aluminum, for example. However, for enhancing the responsiveness of the damping characteristics, it is desired that the first valve element V1 is light in weight so that the first valve element V1 moves easily in response to the flow of the working fluid and/or the fluctuations of the pressure. In the configuration disclosed here, by providing the first slit V15 at the first end portion V1a and/or the second end portion V1b, the weight of the first valve element V1 is reduced. Consequently, the damping mechanism with the enhanced responsiveness to the fluctuations in the pressure of the working fluid can be obtained.

According to the aforementioned embodiment, the damping force variable valve GV includes the first spring S1 provided across the housing H and the first valve element V1, and pushing the first valve element V1 towards the solenoid 4a. The first slit V15 is provided at at least one of the first end portion V1a and the first valve seat R3.

According to the above-described configuration, the opening state of the first valve element V1 is controlled by the solenoid 4a. Even in a case of a failure of the solenoid 4a, the damping force variable valve GV is required to perform a predetermined damping function. In a case where the solenoid 4a fails to operate, the pressing force relative to the first valve element V1 is not provided and the first valve element V1 is moved towards the solenoid 4a by the first spring S1. At this time, the gap formed between the first end portion V1a and the first valve seat R3 is fully widened or increased, and the first pilot chamber PR1 and the second pilot chamber PR2 are in fluid communication with each other.

In the above-described state, the first orifice OR1 or the second orifice OR2, which are provided at the housing H, limits the flow amount of the working fluid, and the predetermined damping effect is achieved. In a state where the plunger 3a withdraws, the interval space between the first end portion V1a and the first valve seat R3 is large enough, and thus the shape of the first slits V15 do not influence the flow amount of the working fluid. Wth the above-described configuration, the predetermined damping function is reliably performed when the solenoid 4a fails to function.

According to the aforementioned embodiment, the first slit V15 is provided at the first end portion V1a.

According to the above-described configuration, the first slit V15 is provided at the first end portion V1a. Consequently, the damping force variable valve GV, in which the weight of the first valve element V1 is reduced and the damping response during the normal operation is enhanced, and the intended damping function is performed reliably when the solenoid 4a fails to function, is achieved.

According to the aforementioned embodiment, the first slit V15 is formed of the elastic material and includes the annular shape, and the first slit V15 includes at least one cut-out portion serving as the opening.

According to the above-described configuration, the elastic material is used for the first slit V15. The pressing capability of the solenoid 4a and the elastic characteristics of the elastic material are combined with each other, and thus the deformation amount of the elastic material can be set arbitrarily. In addition, for setting the deformation amount of the elastic material, it is convenient that the cut-out portion is formed as the opening of the first slit V15. To form the cut-out portion, the end portion of the elastic material may be simply cut off. By deciding the dimensions of each cut-out portion, which includes the width in the circumferential direction of the rubber member, the height in the direction of the axis X and/or the depth in the radial direction of the rubber member, the amount of flow of the working fluid can be set freely. In a case where the plural cut-out portions are provided along the circumferential direction of the elastic material, the cross-sectional shape of the elastic material between the adjacent cut-out portions may be set appropriately, and thus the amount of deformation caused by the solenoid 4a is set easily.

According to the aforementioned embodiment, the first slit V15 is made of the rubber material.

According to the above-described configuration, the first slit V15 is formed of the rubber material, and thus the shape and configuration such as the cut-out portion can be set easily, for example. As a result, an intended deformation is generated in accordance with an extent of increment in the pressing force of the solenoid 4a. Consequently, for example, the flow amount of the working fluid can be set to change in a stepwise manner. Further, as a result of using the rubber material, the noise is restricted from occurring when the first valve element V1 comes in contact with, for example, the first valve seat R3, and accordingly the damping force variable valve GV with the high quality is obtained.

According to the aforementioned embodiment, the actuator 4 corresponds to the solenoid 4a.

According to the above-described configuration, for example, the solenoid 4a can cause the plunger 3a, which is arranged inside, to perform a parallel movement with the use of the magnetic force. Accordingly, the structure for pushing the first valve element V1 can be arranged in the space-saving manner. In addition, the predetermined pressing or pushing force is obtained easily relative to the power supply amount. By combining with the deformation characteristics of the first slit V15, the inexpensive damping force variable valve GV with the compact structure is obtained.

The principles, preferred embodiments and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A damping force variable valve comprising:
a case accommodating working fluid;
a housing dividing an inside of the case into a first fluid chamber and a second fluid chamber;
the housing including a first hole provided at an outer circumferential wall of the housing, the first hole allowing an inner space portion of the housing and the first fluid chamber to be in fluid communication with each other;
the housing including a second hole provided at an end portion of the housing in a direction of an axis, the second hole allowing the inner space portion and the second fluid chamber to be in fluid communication with each other;
a valve element provided at the housing and including a cylindrical shape;
the valve element including a first end portion configured to be in contact with a first contact portion formed at a part of the housing;
the valve element dividing the inner space portion into a first hole pilot chamber being in fluid communication with the first hole and a second hole pilot chamber being in fluid communication with the second hole;
the valve element configured to perform reciprocating motion within the inner space portion along the direction of the axis, a position of the valve element at which the valve element is in contact with the first contact portion corresponding to an end point of the reciprocating motion;
an actuator provided at the housing and including a second contact portion configured to be in contact with a second end portion of the valve element, the second end portion being provided at a side which is opposite to the first end portion in the direction of the axis; and
the actuator configured to move along the axis and set a position of the valve element, wherein
at least one of the first end portion, the first contact portion, the second end portion and the second contact portion is provided with a communication portion including an opening configured to allow the first hole pilot chamber and the second hole pilot chamber to be in fluid communication with each other, and
an opening area of the opening changes in accordance with a pressing force from the actuator.

2. The damping force variable valve according to claim 1, wherein the communication portion is provided at at least one of the first end portion and the second end portion.

3. The damping force variable valve according to claim 1, comprising:
a biasing member provided across the housing and the valve element, and pushing the valve element towards the actuator; and
the communication portion being provided at at least one of the first end portion and the first contact portion.

4. The damping force variable valve according to claim 2, wherein the communication portion is provided at the first end portion.

5. The damping force variable valve according to claim 1, wherein
the communication portion is formed of elastic material to include an annular shape, and
the communication portion includes at least one cut-out portion serving as the opening.

6. The damping force variable valve according to claim 1, wherein the communication portion is made of rubber material.

7. The damping force variable valve according to claim 1, wherein the actuator corresponds to a solenoid.

8. The damping force variable valve according to claim 2, wherein
the communication portion is formed of elastic material to include an annular shape, and
the communication portion includes at least one cut-out portion serving as the opening.

9. The damping force variable valve according to claim 3, wherein
the communication portion is formed of elastic material to include an annular shape, and
the communication portion includes at least one cut-out portion serving as the opening.

10. The damping force variable valve according to claim 4, wherein
the communication portion is formed of elastic material to include an annular shape, and
the communication portion includes at least one cut-out portion serving as the opening.

11. The damping force variable valve according to claim 2, wherein the communication portion is made of rubber material.

12. The damping force variable valve according to claim 3, wherein the communication portion is made of rubber material.

13. The damping force variable valve according to claim 4, wherein the communication portion is made of rubber material.

14. The damping force variable valve according to claim 5, wherein the communication portion is made of rubber material.

15. The damping force variable valve according to claim 2, wherein the actuator corresponds to a solenoid.

16. The damping force variable valve according to claim 3, wherein the actuator corresponds to a solenoid.

17. The damping force variable valve according to claim 4, wherein the actuator corresponds to a solenoid.

18. The damping force variable valve according to claim 5, wherein the actuator corresponds to a solenoid.

19. The damping force variable valve according to claim 6, wherein the actuator corresponds to a solenoid.
